(19) United States
(12) Patent Application Publication
(10) Pub. No.: US 2025/0251546 A1
(43) Pub. Date: Aug. 7, 2025

(54) ARRAYED WAVEGUIDE GRATING DEVICE

(71) Applicant: Molex, LLC, Lisle, IL (US)

(72) Inventors: Taizhong Huang, Zhuhai (CN); Shuyu Zhang, Fremont, CA (US); Senming Gong, Zhuhai (CN); Zhanqiao Zeng, Zhuhai (CN)

(21) Appl. No.: 18/856,895

(22) PCT Filed: May 11, 2023
(86) PCT No.: PCT/IB2023/054894

§ 371 Date: Oct. 15, 2024

(30) Foreign Application Priority Data
May 11, 2022 (CN) 202210513386.0

(51) Int. Cl. G02B 6/12

(52) U.S. Cl. CPC G02B 6/12033; G02B 6/12016; G02B 6/1203

(57) ABSTRACT

An arrayed waveguide grating device comprises a substrate, an arrayed waveguide grating chip, and a pivoting member. The substrate comprises a first plate portion and a second plate portion which are separated; the first plate portion and the second plate portion are made of the same material; the arrayed waveguide grating chip comprises an input planar waveguide; the input planar waveguide comprises a first part disposed at the first plate portion of the substrate and a second part disposed at the second plate portion of the substrate; and the pivoting member is made of a material different from that of the substrate and connects the first plate portion and the second plate portion of the substrate, so that the first plate portion and the second plate portion are movable relative to each other.

### TECHNICAL FIELD

The present invention relates to an arrayed waveguide grating device, and in particular, to an arrayed waveguide grating device with temperature compensation.

### BACKGROUND

Arrayed waveguide gratings (AWG for short) are optical components based on planar optical waveguides, including input waveguides, input planar waveguides, arrayed waveguides, output planar waveguides, and output waveguides. The stability of the central wavelength of an optical system using this type of arrayed waveguide grating is generally desired to be controlled within a certain range. However, the existing AWG chips are sensitive to temperature, and their central wavelengths may drift with temperature changes. Therefore, in the prior art, a temperature compensation assembly is generally used for compensation, so as to control the magnitude of its central wavelength change with temperature.

In addition, it is disclosed in U.S. Patent Publication No. U.S. Pat. No. 7,062,127B2 that, by changing the gap between two regions of a substrate, and by means of a hinge that integrally connects the two regions of the substrate, when the two regions of the substrate are deformed due to temperature changes, they can be rotated and displaced with the hinge as a rotation center. However, the hinge is integrally connected to the substrate, and the manufacturing cost of the substrate is relatively high. Moreover, since the hinge and the substrate are made of the same material, the improvement of the response sensitivity of the hinge to substrate deformation and temperature compensation may also be limited by the substrate.

### SUMMARY

Therefore, an objective of the present invention is to provide an arrayed waveguide grating device, which can improve the temperature compensation sensitivity.

Accordingly, the arrayed waveguide grating device of the present invention comprises a substrate, an arrayed waveguide grating chip, and a pivoting member. The substrate comprises a first plate portion and a second plate portion which are separated, and the first plate portion and the second plate portion are made of the same material. The arrayed waveguide grating chip comprises an input planar waveguide, and the input planar waveguide comprises a first part disposed at the first plate portion of the substrate and a second part disposed at the second plate portion of the substrate. The pivoting member is made of a material different from that of the substrate, and the pivoting member connects the first plate portion and the second plate portion of the substrate, so that the first plate portion and the second plate portion are movable relative to each other.

In some implementations, the first plate portion has a top face and a bottom face opposite to each other: the second plate portion has a top face and a bottom face opposite to each other; the first part of the input planar waveguide is disposed at the top face of the first plate portion, and the second part of the input planar waveguide is disposed at the top face of the second plate portion; and the pivoting member has a first end portion fixed to the bottom face of the first plate portion, and a second end portion fixed to the bottom face of the second plate portion.

In some implementations, the substrate and the pivoting member are individually separate elements.

In some implementations, the arrayed waveguide grating device further comprises a temperature compensation assembly, the temperature compensation assembly comprises two end portions and a movable member which is located between a plurality of end portions and can be displaced relative to at least one of the end portions, and the plurality of end portions are fixed at the first plate portion and the second plate portion of the substrate, respectively.

In some implementations, a gap is formed between the first plate portion and the second plate portion, and the gap comprises a first section and a second section which are in communication with each other and not located at the same line.

In some implementations, the input planar waveguide of the arrayed waveguide grating chip spans the first section of the gap between the first plate portion and the second plate portion.

In some implementations, the temperature compensation assembly spans the second section of the gap disposed between the first plate portion and the second plate portion.

In some implementations, a gap is formed between the movable member and one of the end portions.

In some implementations, the temperature compensation assembly further comprises a connection section connecting the movable member and one of the end portions and passing through the gap between the movable member and the end portion.

In some implementations, the connection section of the temperature compensation assembly is integrally molded with the movable member.

In some implementations, the connection section of the temperature compensation assembly is an element independent of the movable member and the end portion.

The arrayed waveguide grating device of the present invention comprises a substrate, an arrayed waveguide grating chip, and a pivoting member. The substrate comprises a first plate portion, a second plate portion, and a gap located between the first plate portion and the second plate portion. The arrayed waveguide grating chip comprises an input planar waveguide disposed at the first plate portion and the second plate portion across the gap of the substrate. The pivoting member and the substrate are individually separate elements, and the pivoting member spans the gap with one end connected to the first plate portion of the substrate, and the other end connected to the second plate portion of the substrate.

In some implementations, a partial section of the pivoting member spanning the gap is in a necked structure.

In some implementations, the pivoting member is made of a material different from that of the substrate.

The efficacy of the present invention is as follow: the pivoting member is made of a material different from that of the substrate, and in particular, the pivoting member is combined with the substrate as an element independent of the substrate, so that there can be more room for variation in the shape, material and setting position of the pivoting member; and further, its response sensitivity to deformation can be improved through the reduced width of the connection section and the necked section.

In addition, the first plate portion and the second plate portion of the substrate are made of the same material, especially by cutting the same plate material, which is helpful to facilitate manufacturing.

Also, in the temperature compensation assembly, through the formation of the gap, it is helpful to reduce the lateral rigidity of the movable member and improve the degree of freedom and sensitivity of deformation of the movable member. Moreover, because the connection section is in one end of the movable member, whether it is integrally molded with the movable member or is an independent element additionally manufactured and assembled, it is helpful to simplify the manufacture of the movable member and the combination of the movable member and the end portion.

### BRIEF DESCRIPTION OF THE DRAWINGS

Other features and effects of the present invention will be clearly presented in the embodiments with reference to the accompanying drawings, wherein:

FIG. 1 is a schematic view of one embodiment of an arrayed waveguide grating apparatus of the present invention;

FIG. 2 is an enlarged view of a pivoting member of this embodiment;

FIGS. 3A to 3C are schematic views of variations of the pivotal member;

FIG. 4A is a side view of a temperature compensation assembly of this embodiment;

FIGS. 4B to 4E are perspective views of four variations of the temperature compensation assembly of this embodiment;

FIG. 5 is a side view of the temperature compensation assembly of this embodiment, illustrating the position relationship between a movable member and two end portions of the temperature compensation assembly:

FIGS. 6 and 7 are schematic views similar to FIG. 1, respectively, which are another two variants of the arrayed waveguide grating device, illustrating the difference in setting direction of the temperature compensation assembly; and

FIG. 8 is a schematic view similar to FIG. 1, which is still another variant of the arrayed waveguide grating device, illustrating a difference in set angle of a gap.

### REFERENCE SIGNS ARE AS FOLLOWS

100 arrayed waveguide grating device
100″, 100″, 100′″ arrayed waveguide grating device
1 substrate
11 first plate portion
111 top face
112 bottom face
12 second plate portion
121 top face
122 bottom face
13 gap
131 first section
132 second section
2 arrayed waveguide grating chip
20 input waveguide
21 input planar waveguide
211 first part
211a end face
212 second part
22 output planar waveguide
23 arrayed waveguide
24 output waveguide
25 flat substrate
3 pivoting member
31 first end portion
32 second end portion
33 connection section
34 necked section
4 temperature compensation assembly
41, 42 end portion
43 movable member
44 connection section
45 gap
L length direction
W width direction
T thickness direction
W31, W33 and W34 width

### DETAILED DESCRIPTION

Before the present invention is described in detail, it should be noted that in the following description, similar elements are designated by the same reference numerals.

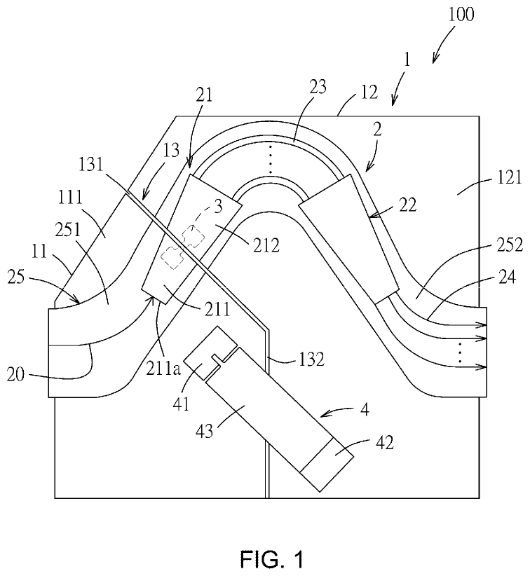

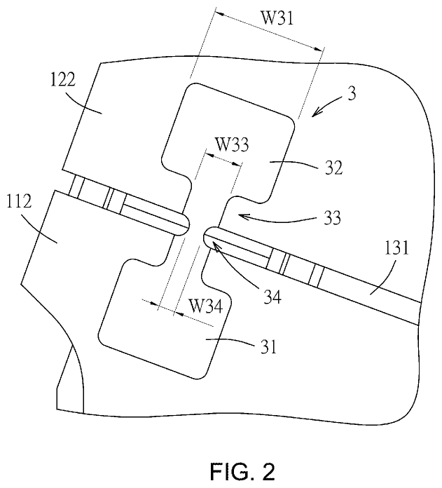

Referring to FIGS. 1 and 2, one embodiment of an arrayed waveguide grating device 100 of the present invention includes a substrate 1, an arrayed waveguide grating chip 2, a pivoting member 3, and a temperature compensation assembly 4.

The substrate 1 may be made of a silicon substrate, Pyrex, or Invar. The substrate 1 includes a first plate portion 11 and a second plate portion 12 which are separated, and the first plate portion 11 and the second plate portion 12 are made of the same material. In the present embodiment, the first plate portion 11 and the second plate portion 12 of the substrate 1 are formed by cutting the same plate material, and the thickness thereof can be determined according to actual needs. The first plate portion 11 has a top face 111 and a bottom face 112 opposite to each other (see FIG. 2), the second plate portion 12 has a top face 121 and a bottom face 122 opposite to each other (see FIG. 2), and a gap 13 is formed in a cut region between the first plate portion 11 and the second plate portion 12. The gap 13 includes a first section 131 and a second section 132 that are in communication with each other and not located on the same straight line, that is to say, the included angle between the first section 131 and the second section 132 is not 180 degrees. The first section 131 extends obliquely, and the second section 132 is in communication with the first section 131 and extends longitudinally. Through the arrangement of the gap 13, a margin space is provided when the first plate portion 11 and the second plate portion 12 of the substrate 1 are deformed due to temperature changes.

The arrayed waveguide grating chip 2 is generally in an inverted U-shaped structure as a whole, and includes a flat substrate 25, and an input waveguide 20, an input planar waveguide 21, an arrayed waveguide 23, an output planar waveguide 22 and an output waveguide 24 which are disposed in the flat substrate 25 and connected sequentially. The input waveguide 20 is disposed at the first plate portion 11 of the substrate 1. The flat substrate 25 includes two parts 251, 252, which are disposed and fixed on the top face 111 of the first plate portion 11 and the top face 121 of the second plate portion 12 of the substrate 1, respectively. The input planar waveguide 21 includes a first part 211 disposed at the first plate portion 11 of the substrate 1 and a second part 212 disposed at the second plate portion 12 of the substrate 1, and the first part 211 and the second part 212 are separated by a first section 131 of the gap 13. The input waveguide 20, and the first part 211 of the input planar waveguide 21 are located in one part 251 of the flat substrate 25, and are fixed on the top face 111 of the first plate portion 11 together with the part 251 of the flat substrate 25 by resin, for example, to form an integral body with the first plate portion 11. The second part 212 of the input planar waveguide 21, the arrayed waveguide 23, the output planar waveguide 22, and the output waveguide 24 are located in another part 252 of the flat substrate 25, and are fixed on the top face 121 of the second plate portion 12 together with another part 252 of the flat substrate 25 by resin, for example, to form an integral body with the second plate portion 12. The aforementioned plurality of waveguides 20, 21, 22, 23, 24 may be made of quartz glass, the flat substrate 25 may be made of a silicon wafer or a quartz glass wafer, and the substrate 1 may also be made of the same as the material of the flat substrate 25.

The pivoting member 3 connects the first plate portion 11 and the second plate portion 12 of the substrate 1, so that the first plate portion 11 and the second plate portion 12 are movable relative to each other. In the present embodiment, the pivoting member 3 is made of a material different from that of the substrate 1, and a material with a relatively stable thermal expansion coefficient may be selected. The pivoting member 3 is generally in the form of an I-shaped plate, and has a first end portion 31, a second end portion 32, a connection section 33 connected between the first end portion 31 and the second end portion 32, and a necked section 34 formed on the connection section 33. The connection section 334 is formed by two side edges of a region between the first end portion 31 and the second end portion 32 of the pivoting member 3 being recessed toward each other, so that the width W33 of the connection section 33 is smaller than the width W31 of the first end portion 31 and the second end portion 32. The necked section 34 is formed by two side edges of a middle partial section of the connection section 33 being recessed toward each other, so that the width W34 of the necked section 34 is smaller than the width W33 of the connection section 33. The first end portion 31 is fixed on the bottom face 112 of the first plate portion 11, and the second end portion 32 is fixed on the bottom face 122 of the second plate portion 12. At this time, the necked section 34 formed on the connection section 33 is located in a gap 131 between the first plate portion 11 and the second plate portion 12 of the substrate 1.

The pivoting member 3 is disposed as a pivotal fulcrum when the first plate portion 11 and the second plate portion 12 of the substrate 1 are deformed due to temperature changes, and as shown in FIG. 2, by means of the reduced width of the connection section 33 and the neck section 34, as the pivotal fulcrum, the pivoting member 3 can further improve its response sensitivity to deformation and temperature compensation. Further, since the pivoting member 3 is an independent element compared with the first plate portion 11 and the second plate portion 12 of the substrate 1, it has a higher degree of freedom in adjusting its shape and material according to requirements.

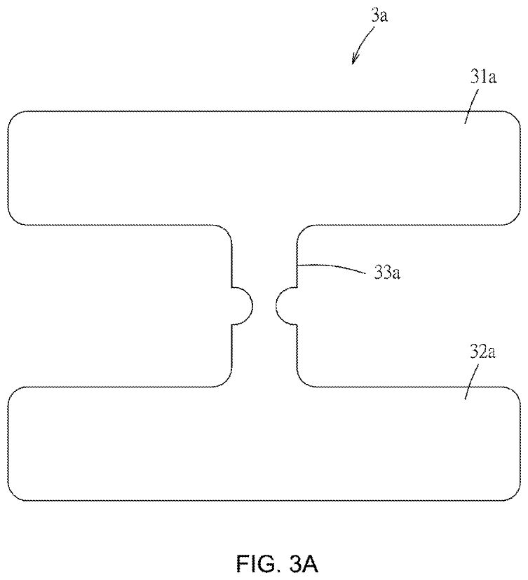

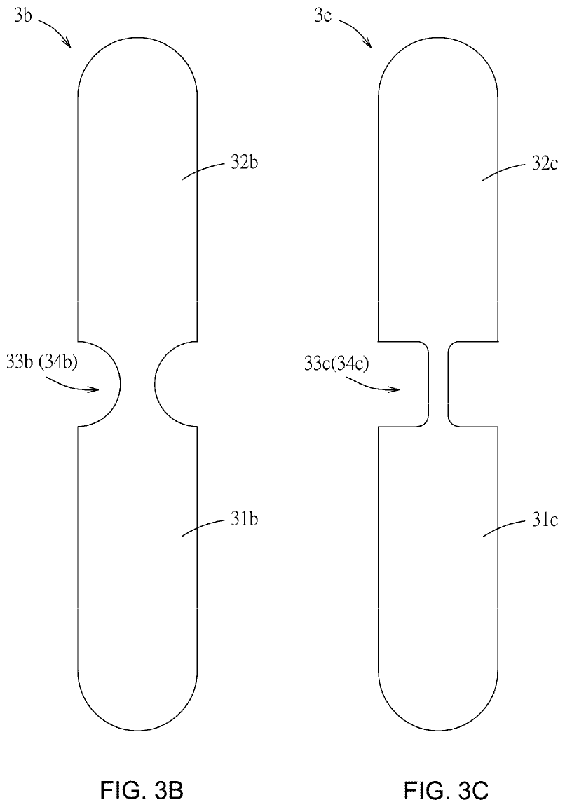

Referring to FIGS. 3A, 3B, 3C, they are three variations of pivoting members 3a, 3b, 3c. In the variation of FIG. 3A, the ratio of the width of the first end portion 31a and the second end portion 32a to the width of the connection section 33a is larger than that in FIG. 2, that is, the first end portion 31a and the second end portion 32a have a greater area provided for being attached and fixed to the first plate portion 11 and the second plate portion 12 of the substrate 1, which is more helpful to improve the performance of temperature compensation on the premise of being more stably fixed and combined with the substrate 1. In the variation of FIG. 3B, two side edges of the connection section 33b have concave arc contours, and the width of the connection section 33b is less than the width of the first end portion 31b and the second end portion 32b. Moreover, the integral or intermediate partial section of the connection section 33b may also be considered to be a necked section 34b due to the width of the tapered width. In the variation of FIG. 3C, two side edges of the connection section 33b have concave square contours, so that the connection section 33c is straight and the width is less than the width of the first end portion 31c and the second end portion 32c. For the pivoting members 3a, 3b, 3c shown in FIGS. 3A to 3C, their response sensitivity to deformation may likewise be further improved.

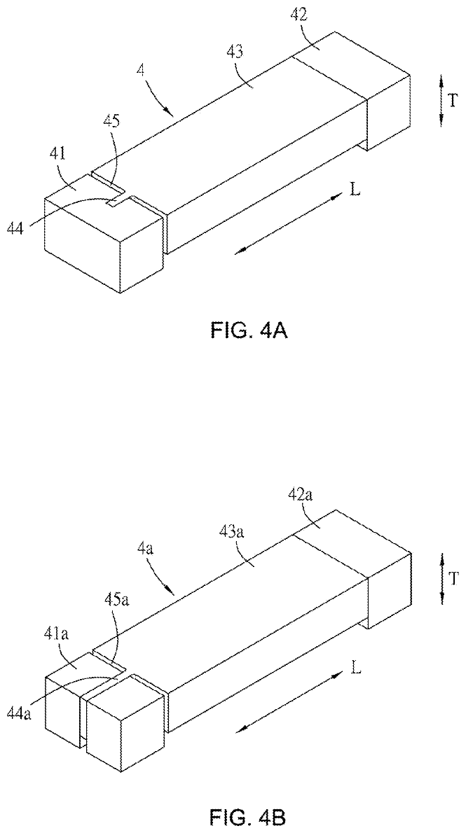

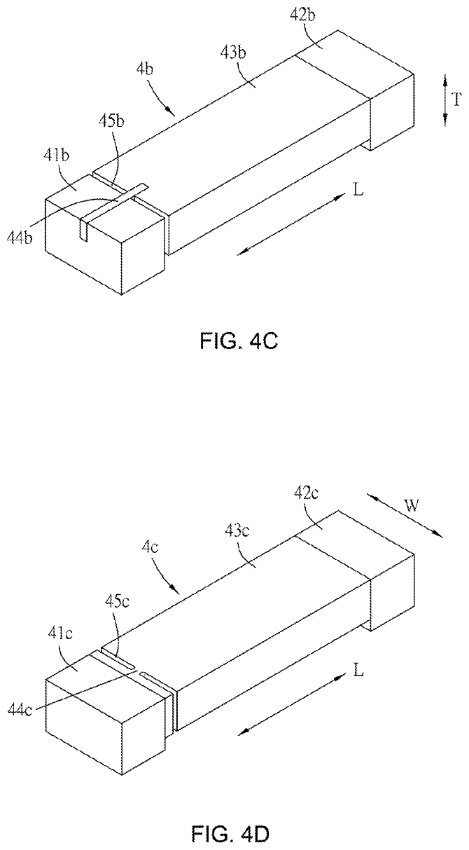

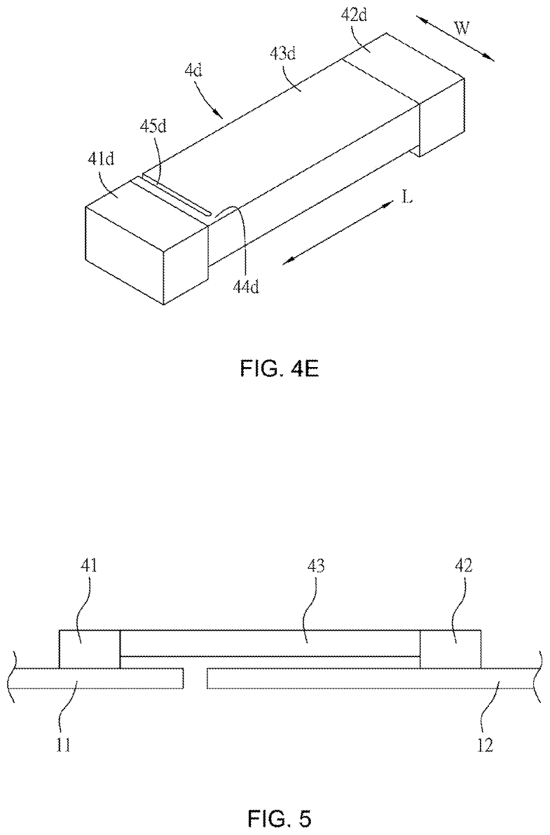

Referring to FIGS. 1, 4A, 5, and 7, the temperature compensation assembly 4 spans the second section 132 of the gap 13 across the first plate portion 11 and the second plate portion 12 of the substrate 1. In the present embodiment, the temperature compensation assembly 4 includes two end portions 41, 42, and a movable member 43, which is located between the two end portions 41, 42 and can be displaced relative to at least one end portion 41. The two end portions 41, 42 may be made of a higher UV light-transmitting material, such as quartz glass, etc. The movable member 43 may be made of a linear stretchable material, a nonlinear stretchable material or a mixture of the above two materials, which has a higher thermal expansion coefficient than that of the substrate 1. For example, a material with a thermal expansion coefficient of 8 to 14 may be selected. In the present embodiment, the movable member 43 is in the shape of a long strip, and the two end portions 41, 42 are in the shape of a block, and fixed to the first plate portion 11 and the second plate portion 12 of the substrate 1, respectively, and connected on both ends of the movable member 43, respectively. At this time, the movable member 43 is spaced over the first plate portion 11 and the second plate portion 12, and a gap 45 is formed between the movable member 43 and one end portion 41. In the present embodiment, the temperature compensation assembly 4 further includes a connection section 44 connecting the movable member 43 and one end portion 41. The connection section 44 is a rib-shaped structure integrally molded along the length direction L of the movable member 43, protruding from one end of the movable member 43 and embedded in the end portion 41, and the connection section 44 is not fully embedded in the end portion 41, so that the gap 45 is formed between one end of the movable member 43 and the end portion 41. Moreover, in the present embodiment, the connection section 44 does not go through the entire end portion 41 along the length direction L of the movable member 43. By means of the partial section of the connection section 44 that is not fully embedded in the end portion 41, the movable member 43 is provided with a margin space that deforms relative to the end portion 41. The deformation may be along the length direction L of the movable member 43, or in a pivoting direction centered on the connection section 44, or a combination of the above two. Referring to FIG. 4B, in a second variation of temperature compensation assembly 4a, the connection section 44 goes through the entire end portion 41 along the length direction L of the movable member 43a, and also goes through the entire end portion 41 in the thickness direction T. Referring to FIG. 4C, in a third variation of temperature compensation assembly 4b, the connection section 44 goes through the entire end portion 41 along the length direction L of the movable member 43b, but does not go through the entire end portion 41b in the thickness direction T of the end portion 41b, and the connection section 44b is a separate element relative to the movable member 43b and the end portion 41b, which is thus helpful to have a greater degree of freedom on the material selection of the connection section 44b, and makes it easier to manufacture.

Referring to FIGS. 4D to 4E, they are another two variations of the temperature compensation assembly 4c, 4d. In the two variations, gaps 45c, 45d are formed at ends of the movable members 43c, 43d close to the ends portions 41c, 41d, and the gaps 45c, 45d do not go through the entire movable members 43c, 43d in the width direction W of the movable members 43c, 43d, thereby forming connection sections 44c, 44d. In FIG. 4D, a gap 45c is divided into two sections, which go through two sides of the movable member 43c, respectively, such that the connection section 44c is between the two sections of the gap 45c. In FIG. 4E, a gap 45d only goes through a single side of the movable member 43d.

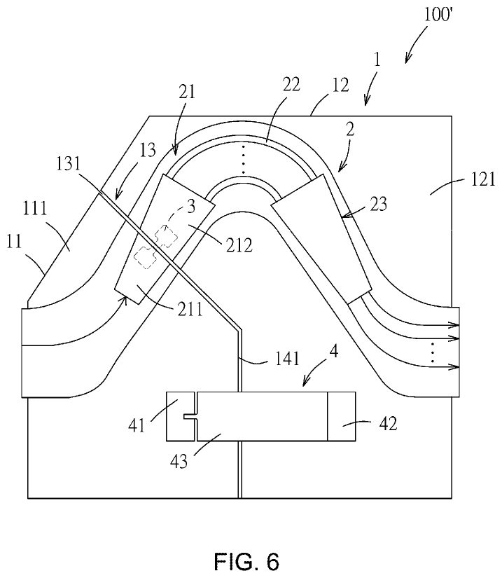

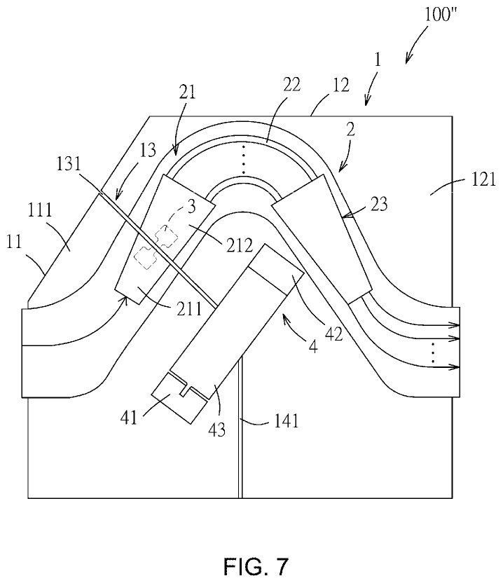

Referring to FIGS. 6 and 7, they are two variations of arrayed waveguide grating devices 100′, 100″ of the present invention, which are different from FIG. 1 in the setting direction of the temperature compensation assembly 4. In FIG. 1, the temperature compensation assembly 4 spans the second section 132 of the gap 13 with the end portion 41 disposed obliquely toward the input planar waveguide 21, whereas in FIG. 6, the temperature compensation assembly 4 spans the second section 132 of the gap 13 and is disposed in the horizontal direction, and in FIG. 7, the temperature compensation assembly 4 spans the connection of the first section 131 and the second section 132of the gap 13 with the end portion 42 disposed obliquely toward the output planar waveguide 22. Regarding the setting direction of the temperature compensation assembly 4 shown in FIGS. 1, 6, and 7, it may be selected according to requirements.

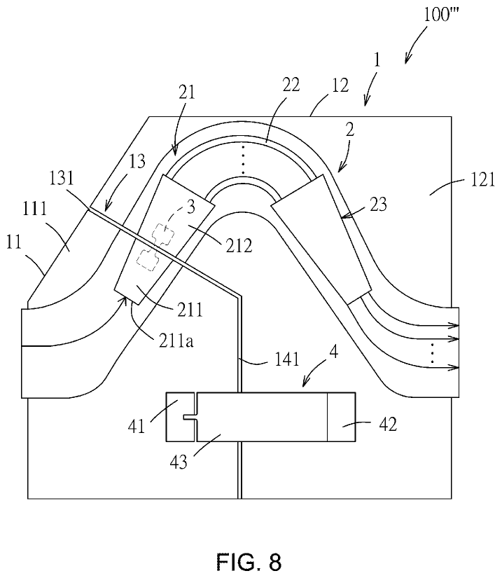

Referring to FIG. 8, it is another variation of arrayed waveguide apparatus 100′″ of the present invention, which is different from FIG. 1 in that in this variation, the extension direction of the first section 131 of the gap 13 is generally parallel to an end face 21 at the connection of the input planar waveguide 21 and the input waveguide 20, that is to say, the extension direction of the first section 131 of the gap 13 is generally perpendicular to the setting direction of the input planar waveguide 21: whereas in FIG. 1, the extension direction of the first section 131 of the gap 13 has an included angle of about 8 degrees with a direction parallel to the end face 211a of the input planar waveguide 21.

In summary, in the present invention, the pivoting member 3 is made of a material different from that of the substrate 1, and in particular, the pivoting member 3 is combined with the substrate 1 as an element independent of the substrate 1, so that there can be more room for variation in the shape, material and setting position of the pivoting member 4; and its response sensitivity to deformation and temperature compensation is improved through the reduced width of the connection section and the necked section. In addition, the first plate portion 11 and the second plate portion 12 of the substrate 1 are made of the same material, especially by cutting the same plate material, which is helpful to facilitate manufacturing. Also, in the temperature compensation assembly 4, through the formation of the gap 45, it is helpful to reduce the lateral rigidity of the movable member 43 and improve the degree of freedom and sensitivity of deformation of the movable member 43. Moreover, as shown in FIGS. 4A to 4C, because the connection section is in one end of the movable member 43, whether it is integrally molded with the movable member 43 or is an independent element additionally manufactured and assembled, it is helpful to simplify the manufacture of the movable member 43 and the combination of the movable member 43 and the end portion 41.

However, the above descriptions are merely examples of the present invention, which should not limit the scope of implementation of the present invention. Any simple equivalent changes and modifications made according to the claims of the present invention shall still fall within the scope of the present invention patent.

1. An arrayed waveguide grating device, comprising:
a substrate comprising a first plate portion and a second plate portion which are separated, wherein the first plate portion and the second plate portion are made of the same material;
an arrayed waveguide grating chip comprising an input planar waveguide, wherein the input planar waveguide comprises a first part disposed at the first plate portion of the substrate and a second part disposed at the second plate portion of the substrate; and
a pivoting member, which is made of a material different from that of the substrate, wherein the pivoting member connects the first plate portion and the second plate portion of the substrate, so that the first plate portion and the second plate portion are movable relative to each other.

2. The arrayed waveguide grating device according to claim 1, wherein the first plate portion has a top face and a bottom face opposite to each other; the second plate portion has a top face and a bottom face opposite to each other; the first part of the input planar waveguide is disposed at the top face of the first plate portion, and the second part of the input planar waveguide is disposed at the top face of the second plate portion; and the pivoting member has a first end portion fixed to the bottom face of the first plate portion, and a second end portion fixed to the bottom face of the second plate portion.

3. The arrayed waveguide grating device according to claim 1, wherein the substrate and the pivoting member are individually separate elements.

4. The arrayed waveguide grating device according to claim 2, wherein the pivoting member further has a connection section connecting the first end portion and the second end portion, and the width of the connection section is less than the width of the first end portion and the second end portion.

5. The arrayed waveguide grating device according to claim 4, wherein the pivoting member further has a necked section formed in the connection section, and the width of the necked section is less than the width of the connection section.

6. The arrayed waveguide grating apparatus according to claim 1, further comprising a temperature compensation assembly, wherein the temperature compensation assembly comprises two end portions and a movable member which is connected between a plurality of end portions and can be displaced relative to at least one of the end portions, and the plurality of end portions are fixed at the first plate portion and the second plate portion of the substrate, respectively.

7. The arrayed waveguide grating device according to claim 6, wherein a gap is formed between the first plate portion and the second plate portion, and the gap comprises a first section and a second section which are in communication with each other and not located at the same line.

8. The arrayed waveguide grating device according to claim 7, wherein the input planar waveguide of the arrayed waveguide grating chip spans the first section of the gap between the first plate portion and the second plate portion.

9. The arrayed waveguide grating device according to claim 7, wherein the temperature compensation assembly spans a second section of a gap disposed between the first plate portion and the second plate portion.

10. The arrayed waveguide grating device according to claim 6, wherein a gap is formed between the movable member and one the end portions.

11. The arrayed waveguide grating device according to claim 10, wherein the temperature compensation assembly further comprises a connection section connecting the movable member and one of the end portions and passing through the gap between the movable member and the end portion.

12. The arrayed waveguide grating device according to claim 11, wherein the connection section of the temperature compensation assembly is integrally molded with the movable member.

13. The arrayed waveguide grating device according to claim 11, wherein the connection section of the temperature compensation assembly is an element independent of the movable member and the end portion.

14. An arrayed waveguide grating apparatus, comprising:
a substrate comprising a first plate portion, a second plate portion, and a gap located between the first plate portion and the second plate portion;
an arrayed waveguide grating chip comprising an input planar waveguide disposed at the first plate portion and the second plate portion across the gap of the substrate; and
a pivoting member, wherein pivoting member the and the substrate are individually separate elements, and the pivoting member spans the gap with one end connected to the first plate portion of the substrate, and the other end connected to the second plate portion of the substrate.

15. The arrayed waveguide grating device according to claim 14, wherein a partial section of the pivoting member spanning the gap is in a necked structure.

16. The arrayed waveguide grating device according to claim 14, wherein the pivoting member is made of a material different from that of the substrate.

17. The arrayed waveguide grating apparatus according to claim 14, further comprising a temperature compensation assembly, wherein the temperature compensation assembly comprises two end portions and a movable member which is connected between a plurality of end portions and can be displaced relative to at least one of the end portions, and the plurality of end portions are fixed at the first plate portion and the second plate portion of the substrate, respectively.

18. The arrayed waveguide grating device according to claim 17, wherein a gap is formed between the movable member and one the end portions.

19. The arrayed waveguide grating device according to claim 18, wherein the temperature compensation assembly further comprises a connection section connecting the movable member and one of the end portions and passing through the gap between the movable member and the end portion.

20. The arrayed waveguide grating device according to claim 19, wherein the connection section of the temperature compensation assembly is integrally molded with the movable member.

21. (canceled)
